(19) United States
(12) Patent Application Publication
(10) Pub. No.: US 2005/0028214 A1
(43) Pub. Date: Feb. 3, 2005

(54) Visual monitoring system and method for use with in-flight air telephone on a mobile platform

(76) Inventor: Patrick J. Hall, Federal Way, WA (US)

Correspondence Address: HARNESS, DICKEY & PIERCE, P.L.C., P.O. BOX 828, BLOOMFIELD HILLS, MI, 48303, US

(21) Appl. No.: 10/628,619

(22) Filed: Jul. 28, 2003

(51) Int. Cl. H04N 7/18

(52) U.S. Cl. 725/105; 348/143

(57) ABSTRACT

A system and method for communicating video signals from a mobile platform, such as a commercial aircraft, to a base station via an existing in-flight telephone system of the mobile platform. At least one camera is disposed in a predetermined area of the mobile platform. The camera communicates with an electronic subsystem having a serial interface port, a CPU and a modem. Video information from the camera (or cameras) is converted into streaming video in accordance with a wide-area network protocol. The wide-area network protocol signals are then converted by the modem into signals suitable for transmission over the existing in-flight telephone system of the mobile platform. The invention is readily retrofittable into existing mobile platforms such as aircraft and allows essentially real-time monitoring of various portions of the aircraft by remotely located personnel.

### FIELD OF THE INVENTION

This invention relates to monitoring systems, and more particularly to a visual monitoring system for monitoring a predetermined area within a mobile platform, such as an aircraft, and generating a video signal which is transmitted over an existing in-flight air telephone subsystem of the mobile platform to a base station.

### BACKGROUND OF THE INVENTION

Video monitoring and surveillance systems are used in a wide variety of applications. However, one particular application which has grown significantly in importance over the past several years involves monitoring a predetermined area within an aircraft, such as, for example, a cockpit. In such applications, providing a system which is relatively low in cost and can be easily integrated into the aircraft without significant modifications to interior areas of the aircraft has proven challenging. Such a system would ideally be able to interface with an existing in-flight telephone system of the aircraft so as to be able to send video information via a wireless connection to a remote location, for example, a ground station, without the need for satellite-based transponders or other expensive systems. The ability to wirelessly provide a video signal to a ground-based station using an existing in-flight telephone system would provide a means for economically providing real-time video information of events occurring within a predetermined area of the aircraft, such as within the cockpit, to personnel at a ground station or at some other remote location. Such information would be extremely useful in allowing individuals at the ground station to follow operations/events occurring on the aircraft. If such cameras are mounted in the passenger cabin area of the aircraft, the video information transmitted from the aircraft to the ground station could be used by ground-based personnel to advise crew members of a developing disturbance on the aircraft.

Accordingly, there exists a need for an easy-to-implement, relatively low-cost system for visually monitoring one or more distinct areas within a mobile platform and providing wireless signals to a remote location via an existing in-flight telephone system of the mobile platform.

### SUMMARY OF THE INVENTION

The present invention is directed to a visual monitoring system for monitoring an interior area of a mobile platform and providing a wireless video signal to a base station via an in-flight telephone system located on the mobile platform. In one preferred form at least one camera is positioned within a predetermined area of the mobile platform. The system further includes an electronic subsystem that is adapted to be disposed within the mobile platform and in communication with the camera, for receiving an output video signal from the camera. The electronic subsystem includes a processor for converting the output video signal from the camera to a streaming video signal suitable for transmission in accordance with a wide area network protocol. In one preferred form, the streaming video signal comprises an Internet protocol streaming video signal. The electronic subsystem includes a modem for converting the streaming video signal into a data stream suitable for transmission via the existing in-flight telephone system on the mobile platform to the base station.

In one preferred form the electronic subsystem forms a single module disposed on a single-printed circuit board. In a preferred embodiment, the interface between the camera and the electronic subsystem is accomplished by an interface port, and in one preferred form by Universal Serial Bus (USB) serial port.

The system operates in real time to generate an output video signal from the camera disposed on the mobile platform. The output video signal is converted to a streaming video signal in accordance with a wide area network protocol, and then subsequently converted by the modem to a streaming video signal which can be transmitted over the existing in-flight telephone system of the mobile platform. The system provides the advantage of video signals that are relayed to the ground station in substantially real time. In another preferred embodiment, a plurality of video cameras are incorporated, with one camera disposed within the cockpit of an aircraft, and at least one other camera disposed within a passenger cabin area of the aircraft. Both cameras generate output video signals that are received by the electronic subsystem and subsequently transmitted over the in-flight telephone system of the aircraft to the ground station.

The system of the present invention is readily retrofittable to existing mobile platforms, and particularly to existing commercial and military aircraft. The system does not take up appreciable space on the aircraft nor require significant resources from the aircraft other than a supply of power and the use of the in-flight telephone system.

The system provides valuable real-time video information of events occurring in the cockpit and/or passenger cabin areas (or other areas) of the aircraft (or other form of mobile platform) where a camera has been positioned to view a designated area. Ground-based personnel viewing the video received from the aircraft are able to assist the crew members of the aircraft in managing events occurring on the aircraft.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified perspective view showing a portion of a cockpit and a passenger cabin area of a mobile platform, in this example a commercial aircraft, illustrating a pair of cameras positioned to image the cockpit and passenger cabin areas of the aircraft;

FIG. 2 is a simplified block diagram of the overall visual monitoring system of the present invention; and

FIG. 3 is a flowchart of the steps of operation implemented by the system of FIG. 2.

### DETAILED DESCRIPTION OF THE PREFERRED EMBODIMENTS

The following description of the preferred embodiments is merely exemplary in nature and is in no way intended to limit the invention, its application, or uses.

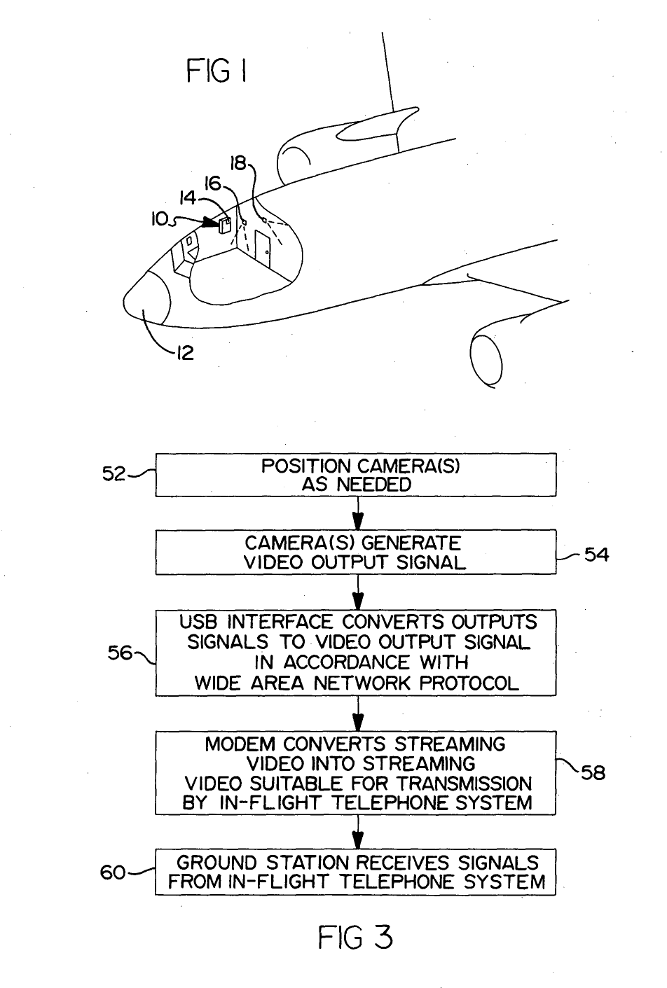

Referring to FIG. 1, there is shown a visual monitoring system 10 in accordance with a preferred embodiment of the present invention disposed on a mobile platform, in this example a commercial aircraft 12. The system 10 generally includes an electronic subsystem 14 and at least one camera 16 in communication with the electronic subsystem 14. FIG. 1 illustrates an optional second camera 18 to highlight that a plurality of cameras may be included at various areas of the aircraft 12. Camera 16 is directed to image a cockpit area of the aircraft 12 while camera 18 is directed to image a passenger cabin area of the aircraft. While the mobile platform has been referred to herein as a commercial aircraft, it will be appreciated that the present invention can be incorporated for use on virtually any form of mobile platform such as a ship, bus, train, rotorcraft, etc. The following discussion of various preferred embodiments of the present invention should therefore not be construed as being limited to any particular type of mobile platform.

The electronic subsystem 14 is shown as being disposed within a cockpit area of the aircraft 12, but it will also be appreciated that this component could be mounted at a plurality of other locations within the aircraft. Preferably, however, electronic subsystem 14 is located in an area that provides easy access thereto in the event servicing is needed.

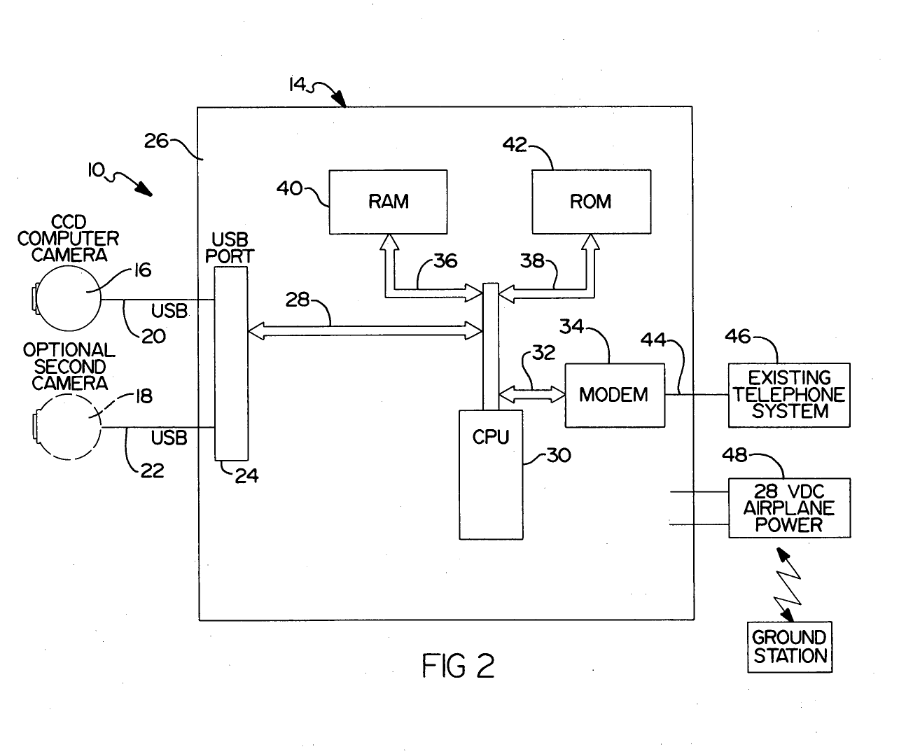

Referring to FIG. 2, the system 10 is shown in greater detail. Each of cameras 16 and 18 are coupled by suitable video cables 20 and 22 to an interface port 24 of the electronic subsystem 14. The electronic subsystem 14 is preferably enclosed within an enclosure 26 that contains all the components (except the cameras 16 and 18) of the system 10, thus forming a relatively compact and easy-to-mount subsystem. It will be appreciated, however, that one or more of the various components associated with the electronic subsystem 14 could be located outside the enclosure 26 if needed.

The interface 24 is in communication via a bus 28 with a central processing unit (CPU) 30. The CPU 30 is in communication via a bus 32 with a modem 34. The CPU 30 is further in communication via buses 36 and 38 with a random-access memory (RAM) 40 and a read-only memory (ROM) 42, respectively. The modem 34 is preferably at least a 56K baud modem and includes an output 44 which is coupled to an input of an existing in-flight telephone system 46. The electronic subsystem 14 receives DC power from a 28-volt DC power bus 48. The CPU 30 may comprise an 8-bit, 16-bit or 32-bit processor.

The CPU 30 includes an operating system, interface port drivers for the interface port 24, web-cam drivers for the cameras 20 and 22, suitable streaming video software, TCP IP drivers, a serial port driver, a modem driver and a telephone connect application S/N Typically, commercially available application software packages would be used to capture the video image, format it for transmission, and provide the telephone dialing communication protocol functions. In one preferred form the interface port 24 comprises a universal serial bus (USB) interface port. The CPU Operating System software includes USB port drivers. RAM 40 is used for image data buffering, application software and the operating system. ROM 42 is used for storing the operating system software, application software and the various drivers mentioned above in lieu of mechanical storage media, such as a hard drive.

In one preferred form the cameras 16 and 18 each include charge-coupled display (CCD) devices that essentially function as computer cameras. However, any form of camera capable of providing an electronic output (either digital or analog) could be integrated to operate with the system 10 with little or no modification.

Referring to FIG. 3, the operation of the system 10 will now be described. Initially, at step 52, the cameras 16 and 18 are positioned as needed to view predetermined areas within the aircraft 12. At step 54, the cameras generate electronic video output signals that are representative of the areas that they are positioned to image. At step 56, the USB port 24 converts the video output signals to streaming video signals in accordance with a wide-area network protocol. In one preferred form, the streaming video output signals comprise Internet protocol streaming video output signals.

At step 58, the CPU 30 causes the streaming video output signals to be transmitted to the modem 34, which in turn converts the streaming video output signals into signals suitable for transmission by the in-flight telephone system 46. At step 60, the in-flight telephone system 46 transmits the video information to the ground station 50. Suitable decoding/demodulating equipment at the ground station 50 converts this information back into a video signal that can be displayed on a suitable monitor. Such a monitor might comprise an LCD display, a CRT display or any other form of video display apparatus. In this manner, the ground personnel at the ground station 50 can assist in monitoring various portions of the aircraft 12 and possibly advise/assist crew members in monitoring/managing situations that may develop on the aircraft.

It will also be appreciated that while the ground station 50 is implied as being a ground-located system, the ground station could in fact be disposed on a different moving platform. Accordingly, the system 10 can be used to transmit video signals from cameras within the aircraft 12 to other aircraft or other mobile devices as well as to a fixed, ground-based installation.

The system and method of the present invention 10 thus forms a means for supplying essentially real-time video signals from a mobile platform, such as aircraft 12, via an existing in-flight telephone system of the mobile platform. System 10 can be easily be retrofitted to existing aircraft and does not require considerable space on the aircraft, and represents a relatively low cost means for providing substantially real time images of selected interior areas of the aircraft.

The description of the invention is merely exemplary in nature and, thus, variations that do not depart from the gist of the invention are intended to be within the scope of the invention. Such variations are not to be regarded as a departure from the spirit and scope of the invention.

1. A visual monitoring system for monitoring an interior area of a mobile platform and providing a video signal to a remotely located monitoring station, the system comprising:
at least one camera positioned within a predetermined area of said mobile platform; and
an electronics subsystem adapted to be disposed within the mobile platform, and in communication with said camera, for receiving an output video signal from said camera;
said electronics subsystem including:
a processor for converting said output video signal to a streaming video signal suitable for transmission in accordance with a wide area network protocol; and
a modem for converting said streaming video signal into a data stream output for transmission over an existing in-flight telephone system on said aircraft to said monitoring station.

2. The system of claim 1, wherein said electronics subsystem is contained within a single enclosure.

3. The system of claim 1, wherein said processor comprises:
a central processing unit; and
a random access memory in communication with said central processing unit.

4. The system of claim 1, further comprising:
a read only memory in communication with said central processing unit for storing a driver used by said central processing unit.

5. The system of claim 1, further comprising a universal serial bus (USB) port for interfacing said output of said camera with said processor.

6. The system of claim 1, wherein said camera comprises a charge coupled display (CCD) camera.

7. The system of claim 1, wherein said streaming video signal comprises an Internet protocol video signal.

8. A visual monitoring system for monitoring an interior area of a mobile platform and providing a video signal representative of said interior area to a remotely located monitoring station, the system comprising:
at least one camera positioned within a predetermined area of said mobile platform; and
a compact electronics component carried in the mobile platform and located remotely from said camera, and in communication with said camera, for receiving an output video signal from said camera;
said compact electronics component including:
an enclosure;
a processor disposed within said enclosure for converting said output video signal to a streaming video signal suitable for transmission in accordance with a wide area network protocol; and
a modem disposed within said enclosure for converting said streaming video signal into a data stream output for transmission over an existing in-flight telephone system on said mobile platform to said base station.

9. The system of claim 8, wherein said streaming video signal comprises an Internet protocol video signal.

10. The system of claim 0.8, further comprising a random access memory and communicating with said processor.

11. The system of claim 8, further comprising a read only memory (ROM) communicating with said processor.

12. The system of claim 8, further comprising a plurality of cameras disposed at a plurality of locations within said mobile platform and communicating with said processor.

13. The system of claim 8, further comprising a Universal Serial Bus (USB) port for interfacing said camera with said processor.

14. The system of claim 8, wherein said camera comprises a charge coupled device (CCD) camera.

15. A visual monitoring system for monitoring an interior area of an aircraft and providing a video signal representative of said interior area to a ground station via an existing in-flight telephone system on the aircraft, the system comprising:
at least one camera positioned within a predetermined area of said aircraft for generating an output video signal representing a designated area which said camera is focused on; and
a compact electronics component carried in the aircraft and located remotely from said camera, and in communication with said camera, for receiving said output video signal from said camera;
said compact electronics component including:
an enclosure;
an interface port associated with said enclosure for interfacing with said camera to receive said output video signal;
a central processing unit disposed within said enclosure and in communication with said interface port for converting said output video signal to a streaming video signal suitable for transmission in accordance with a wide area network protocol; and
a modem disposed within said enclosure in communication with said central processing unit for converting said streaming video signal into a data stream output for transmission over said existing in-flight telephone system on said aircraft to said ground station.

16. The system of claim 15, wherein said interface port comprises a Universal Serial Bus (USB) port.

17. The system of claim 15, wherein said streaming video signal comprises an Internet protocol streaming video signal.

18. The system of claim 15, wherein said camera comprises a charge coupled device (CCD) camera.

19. The system of claim 15, further comprising a plurality of cameras disposed in predetermined locations within said aircraft and simultaneously interfaced with said interface port for providing video pictures of said predetermined locations within said aircraft.

20. A method for visually monitoring a predetermined location within a mobile platform and providing a substantially real time video signal representative of said predetermined location to a base station via an existing in-flight telephone system of said mobile platform, said method comprising:
using a camera to monitor a predetermined location within said mobile platform and to generate an output video signal in accordance therewith;
using an electronics subassembly to receive said output video signal and to convert said output video signal into a streaming video signal in accordance with a wide area network protocol; and
using said electronics subassembly to convert said streaming video signal into a format suitable for transmission over said existing in-flight telephone system to said base station.

21. The method of claim 20, wherein using said electronics subassembly to convert said streaming video signal comprises using a modem.

22. The method of claim 20, wherein using said camera comprises using a charge coupled device (CCD) camera.

23. The method of claim 20, wherein using said electronics subassembly to receive said output video signal comprises using a universal serial bus (USB) interface to receive said output video signal and to convert said output video signal into said streaming video signal.
